(19) United States
(12) Patent Application Publication
(10) Pub. No.: US 2012/0013988 A1
(43) Pub. Date: Jan. 19, 2012

(54) HEAD MOUNTED DISPLAY HAVING A PANORAMIC FIELD OF VIEW

(76) Inventor: Richard A. Hutchin, Calabasas, CA (US)

(21) Appl. No.: 12/974,475

(22) Filed: Dec. 21, 2010

Related U.S. Application Data
(60) Provisional application No. 61/364,924, filed on Jul. 16, 2010.

(51) Int. Cl. G02B 27/01

(52) U.S. Cl. 359/631

(57) ABSTRACT

A head mounted display (HMD) capable of a panoramic field of view. a concave image source is optically coupled in series to a first hemispherical lens, a second hemispherical lens, and a spherical mirror. Each of the concave image source, the first and second hemispherical mirrors, and the spherical mirror are optically concentric.

### PRIORITY

Priority is claimed to U.S. provisional application No. 61/364,924, filed Jul. 16, 2010, the disclosure of which is incorporated herein by reference in its entirety.

### BACKGROUND OF THE INVENTION

1. Field of the Invention

The field of the present invention relates to head mounted displays (HMD) that provide a wide, ultra wide, or panoramic field of view for the user.

2. Background

An HMD is often used as a personal portable display system. An HMD is worn on the head, and the images are displayed directly in front of one eye (monocular HMD), or both eyes (binocular HMD). A typical HMD has either one or two small displays with lenses and semi-transparent mirrors embedded in a helmet, eye-glasses or a visor.

Types of images displayed on HMDs can differ. Some HMDs show computer generated images (CGI) only, whereas others show real images captured by a camera or a combination of both CGI and real images. Most HMDs display only a CGI, sometimes referred to as a virtual image. Some HMDs allow superimposing a CGI upon a real image. This is sometimes referred to as augmented reality or mixed reality.

Some HMDs incorporate peripheral sensors that track the position of the user's head or track the user's eyes. The data from such sensors are used to generate the appropriate CGI for the angle-of-look at the particular time. This allows users to “look around” the displayed environment simply by moving their head or eyes without needing a separate controller to change the angle of the displayed imagery.

A binocular HMD can create three dimensional images for the user by displaying a different image to each eye. One common way to do this is to introduce binocular disparities or differences in the coordinates of corresponding objects between the left and right eye images. Objects in the distance have no disparity hence the coordinates in the left and right eye images are identical, whereas, close objects have binocular disparities. The greater the disparity the closer the object appears to be.

Size, weight and mobility are three of the more important factors for HMDs. A lightweight and small HMD that allows its user to move around with ease is desirable. Besides these three physical constraints, two other important attributes of an HMD are field of view and resolution.

Field of view is important because it determines the level of immersion in the environment displayed by the HMDs. High immersion is useful and desirable for entertaining and training purposes. The human visual field spans a near 200 degree horizontal and 90 degree vertical field of view. Each eye has about a 150 degree horizontal field of view, and the binocular overlap is about 100 degrees. Most HMDs offer a much narrower field of view. Many users feel that a minimum of 100 degree horizontal field of view and 45-50 degree vertical field of view can achieve good immersion and situational awareness.

Resolution is an important factor in determining the realism of the displayed images. Higher resolution throughout the visual field brings out fine detail in a scene, which makes images look more realistic. A reasonable estimate of the visual acuity for a person with 20/20 vision is 60 pixels per degree. This implies that to match human visual quality, an HMD with a field of view of 40 degrees horizontal and 30 degrees vertical (or, 40°×30° H×V) would need to present 2400×1800 pixels. Currently available high-end HMDs typically offer from 1280×1024 to 1920×1200 pixels per eye (mostly with 15-20 pixels/degree).

Various approaches to generate large field of view have traditionally included very large systems or smaller scanning systems. To provide high resolution some systems have relied on eye tracking to keep the high resolution portion centered on the eye.

### SUMMARY OF THE INVENTION

The present invention is directed toward an HMD that produces large field of view and high resolution imagery centered on the eye naturally. The eyes don't have to be in any precise location nor do they need to be tracked in order to see a high quality image. This eliminates the need to tightly control the position of the head and the eyes relative to the projection system and makes it much easier to deploy the system commercially. One can build a few sizes to accommodate almost every user.

The HMD includes a concave image source which can be generated by placing an optical element on or near a flat surface display to create a concave rendering of the image shown on the conventional flat display. Some of the most conventional flat displays currently available on the market are a CRT (cathode ray tube), LCD (liquid crystal display), Liquid crystal on silicon (LCos), plasma, DMD (digital micromirror device), LED (light emitting diode), or OLED (organic light emitting diode) display unit. Other types of flat surface displays may also be used.

The optical elements of a monocular version of the HMD, besides the concave image source, are two hemispherical lenses that are abutted flat surface to flat surface, a beam splitter and a spherical mirror. The spherical mirror is placed in front of the eye such that the center of the mirror sphere coincides with the center of rotation for the eye. All optical elements can be mounted inside a helmet, eye-glasses or a visor.

A binocular version of the HMD includes one monocular version of the HMD for each eye. Three dimensional images can be created for the user by displaying a different image to each eye.

### BRIEF DESCRIPTION OF THE DRAWINGS

In the drawings, wherein like reference numerals refer to similar components:

FIG. 1 schematically illustrates the side view cross section of an HMD;

FIG. 2 schematically illustrates the HMD of FIG. 1 with the optics unfolded;

FIG. 3A schematically illustrates the rays from an HMD to the eye with a 30 degree look down angle;

FIG. 3B schematically illustrates the rays from an HMD to the eye with a 25 degree look up angle;

FIG. 4 illustrates the geometric relationships in the placement of the elements of an HMD;

FIG. 5 schematically illustrates an optical system that makes a flat display appear to be a concave display; and

FIG. 6 schematically illustrates a vision correcting element addition to the HMD.

### DETAILED DESCRIPTION OF THE PREFERRED EMBODIMENTS

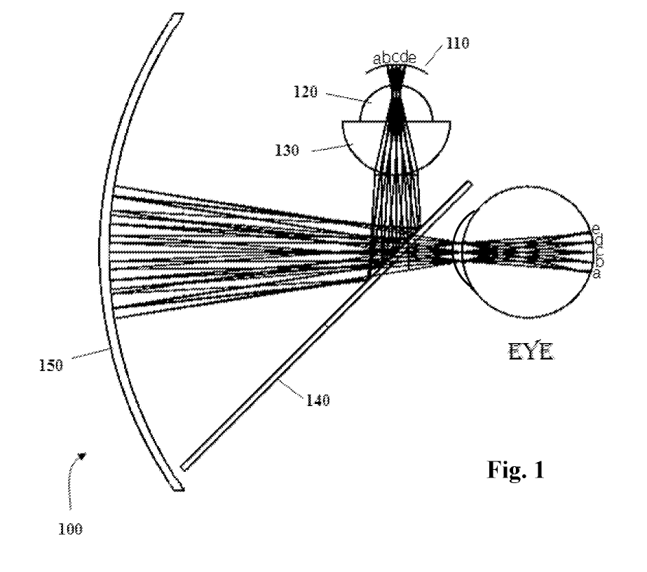

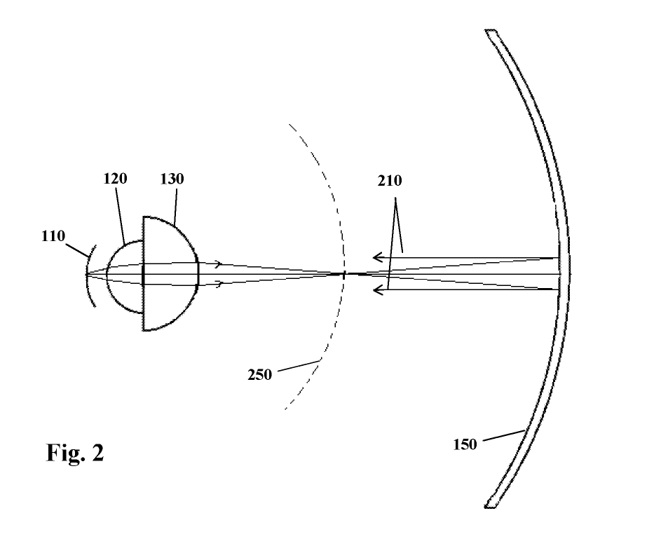

Turning in detail to the drawings, FIG. 1 illustrates the cross section side view of the head mounted display (HMD) 100. As described herein, the HMD is capable of providing the wearer with a panoramic field of view. The optical elements of the HMD 100 are a concave image source 110, a first hemispherical reimaging lens 120, a second hemispherical reimaging lens 130 abutted to the first hemispherical reimaging lens, a beam splitter 140, and a spherical mirror 150. The image originates from the concave image source 110. The concave image source 110 may be a display with a spherical concave surface or a conventional flat display accommodated with a field lens as explained later. A blazed grating (not shown) or diffuser (not shown) may be disposed in close proximity to the concave image source 110 in order to direct and better transmit the light through the optical path towards the eye. The next two optical elements in the optical train after the concave image source 110 are the two hemispherical reimaging lenses 120, 130. The spherical surfaces of these two hemispherical lenses 120, 130 are at least optically concentric with the concave image source 110. As shown, they are also geometrically concentric with the concave image source 110. These two lenses may be made all of one material or each hemispherical lens may be made of a different material for enhanced performance. There may even be multiple concentric regions of different materials within each hemispherical lens, as long as approximate spherical symmetry is maintained. There may also be a stop positioned at or near the middle of the surface where the two hemispherical lenses are joined to restrict the light transmitted. The two hemispherical lenses 120, 130 image source points on the concave image source 110 onto a virtual spherical surface 210, which is shown in FIG. 2. The virtual spherical surface 210 has half the radius of the spherical mirror 150 and is also optically concentric with the hemispherical lenses 120, 130. Note that even though ideally the elements would be positioned so that the geometric relationships are perfect, such precise positioning may not be practical in actual implementation. Nonetheless, approximately achieving these relationships will result in an HMD that delivers the desired panoramic field of view to the user.

Since the paraxial focal length of a spherical mirror is half its radius, this optical train allows the spherical mirror 150 to substantially collimate light from the hemispherical lenses 120, 130 upon reflection. A beam splitter 140 is optically disposed between the hemispherical lenses 120, 130 and the spherical mirror 150. The beam splitter 140 may be a flat semi-transparent mirror or pellicle which partially transmits and partially reflects the light incident on it. Some of the light passing through the second hemispherical lens 130 reflects from the beam splitter 140 towards the spherical mirror 150 and the remaining light passes through the beam splitter 140. Most of the remaining light that passes through the beam splitter 140 is pointed away from the eye and does not create an image viewable by the user. The light directed at the spherical mirror 150 then reflects from the spherical mirror 150 back towards the beam splitter 140. As indicated, the light reflected back from the spherical mirror 150 is substantially collimated. Some of this collimated light is reflected from the beam splitter and directed back to the center of the dual hemispherical lenses 120, 130 and some of it passes through the beam splitter 140 and is directed to the eye. The center of rotation of the eye is positioned approximately where the center of the two hemispherical lenses 120, 130 would be in an unfolded optical system (See FIG. 2). In this manner, every point on the concave image source 110 becomes a nearly collimated beamlet at the center of the eye and thus also at the pupil of the eye.

The rays shown in FIG. 1 span over a 40 degree cone (or, +/−20 degrees) from the center of gaze. The points labeled a, b, c, d and e on the concave image source 110 are mapped to points on the retina of the eye labeled with the same letters. The point labeled c corresponds to the pixel at the center of the concave image source.

The highest quality beam area will be close to the center of the pupil of the eye in whatever direction it looks which supports foveal vision. In areas further from the foveal center, the beam will have somewhat reduced quality, but it will still be suitable for peripheral visual perception. This construct gives the wearer of the HMD full peripheral vision as well as full resolution foveal vision in every direction at all times.

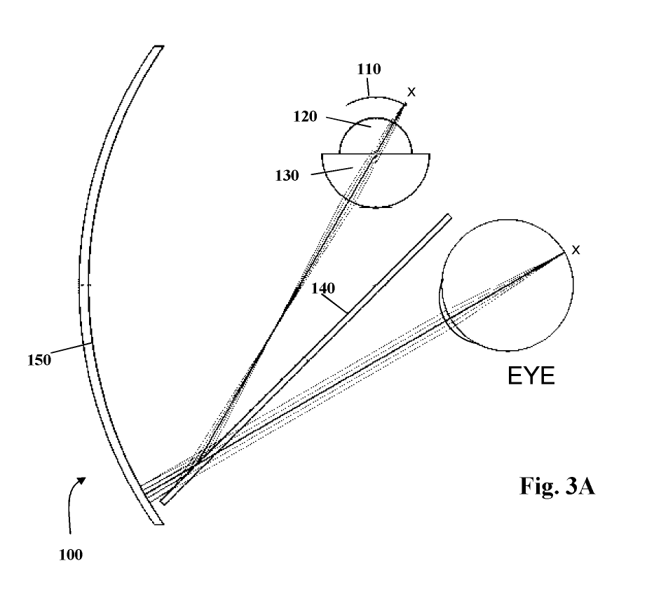

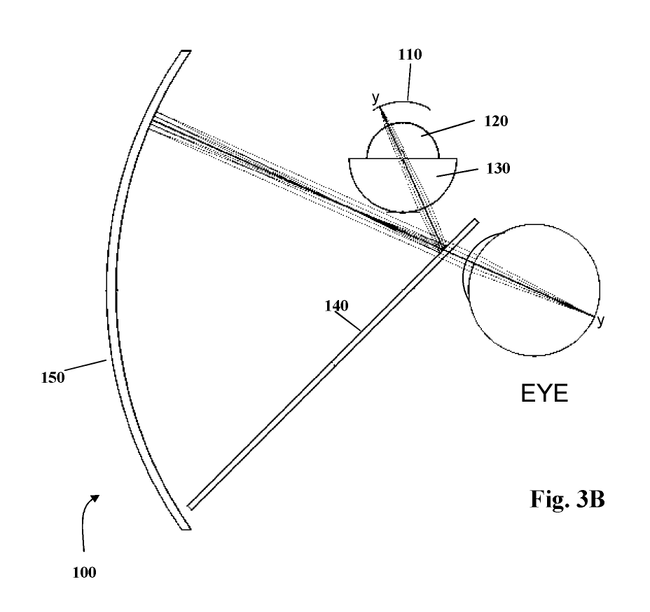

FIG. 3A illustrates the rays from one edge of the concave image source 110 to the eye while the user is looking down. The actual lookdown angle shown is 30 degrees. FIG. 3B illustrates the rays from the other edge of the concave image source 110 to the eye when the user is looking up. The actual lookup angle shown is 25 degrees. The horizontal field of view (i.e., the user looking left and right) extends out of plane of the drawing. The horizontal field of view is determined by the extent of the source 110 in the horizontal direction and the size of the beamsplitter 140 and the spherical mirror 150. The hemispherical lenses 120 and 130 support high resolution imaging over almost a full hemisphere and do not appreciably limit field of view.

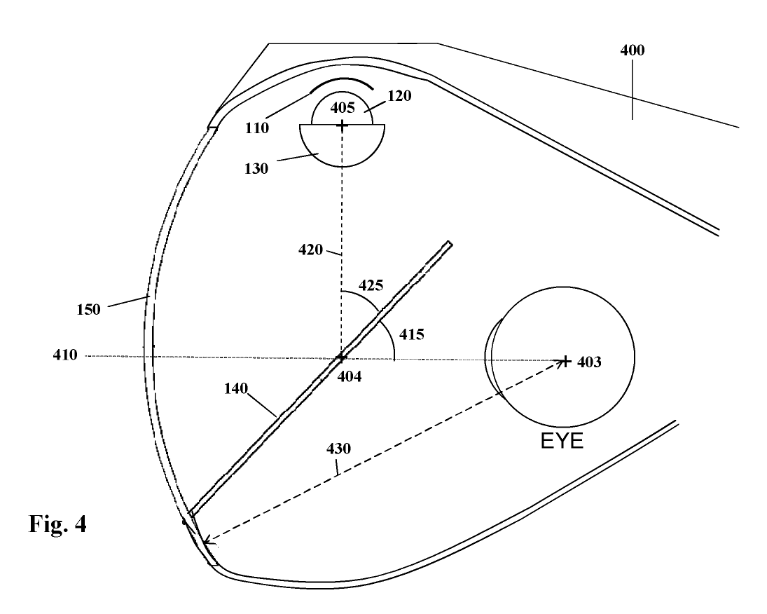

FIG. 4 illustrates the geometric relationships between the positions of the elements of the HMD 100 with the elements mounted onto a frame 400. A line 410 is drawn through the center of rotation for the eye 403 and the center of the pupil of the eye while the gaze is directed at infinity with zero degree horizontal and zero degree vertical deviance from the center of gaze. The point 404 where the line 410 intersects the beam splitter 140 is marked. Another line 420 is drawn from the point 404 to the center of the hemispherical lenses 405. To maintain the necessary geometry, the distance from the center of rotation for the eye 403 to the point 404 on the beam splitter 140 should approximately equal the distance from the center of the hemispherical lenses 405 to the same point 404 on the beam splitter 140. At the same time, the angle 425 formed between the plane of the beam splitter 140 and the line 420 should approximately equal the angle 415 formed between the plane of the beam splitter 140 and the line 410. Moreover, the spherical center of the spherical mirror 150 should substantially coincide with the center of rotation for the eye 403 and the radius of curvature 430 of the spherical mirror 150 should be approximately be equal to the distance between the center of rotation for the eye 403 and the spherical mirror 150. Constructed in this manner, the paraxial rays reflected from the spherical mirror 150 arrive close to the center of the eye regardless of the part of the spherical mirror 150 to which the gaze of the eye is directed. This way, the highest quality imagery will be sent to the foveal region of the retina for all directions of gaze directed at the spherical mirror 150.

An optically equivalent concentric geometry involves switching of the position of the eye with the two hemispherical lenses and the concave image source. In this case, the center of rotation of the user's eye is no longer the geometrical center of the spherical mirror even though the eye and the spherical mirror remain optically concentric. For a more compact HMD, at least one of the hemispherical lenses and the eye should be geometrically concentric with the spherical mirror. In a less compact HMD both the hemispherical lenses and the eye may be only optically concentric with the spherical mirror, with neither being geometrically concentric.

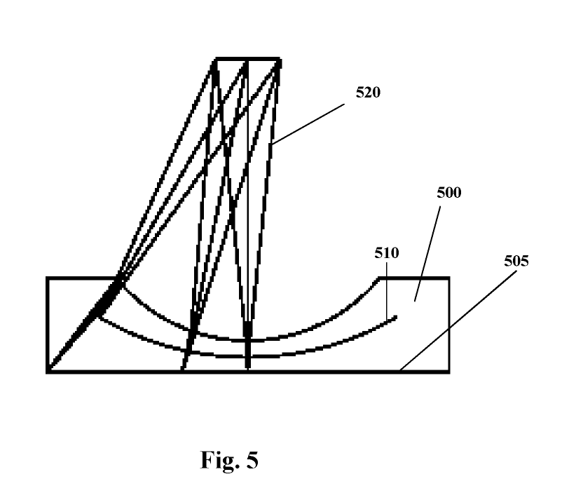

In FIG. 5, an optical element 500 is used to generate the concave image source 110. The optical element 500 is abutted to a flat display surface 505. The optical element 500 transforms the image displayed on the flat display surface 505 into a concave image 510 by bending the rays 520 emanating from the display surface 505. In doing so, the optical element 500 is functioning as a reverse field flattener by introducing more curvature into the optical system, as opposed to removing curvature from the system in the manner that field flatteners have traditionally been used. Field flatteners have been known to those skilled in the relevant arts for over a century. The flat display may be any conventional display such as a CRT (cathode ray tube), an LCD (liquid crystal display), a Liquid crystal on silicon (LCos) display, a plasma display, a DMD (digital micromirror device), an LED (light emitting diode) display, an OLED (organic light emitting diode) display, and the like.

Vision correcting elements (e.g., power and astigmatism) can be added to the HMD 100 so that the users can see the entire field with excellent clarity even if they have limited focus accommodation and require ophthalmic correction. Thus the visual experience of using the HMD may be superior for some people to real life vision even when corrected by glasses since the entire scene will be at infinity focus even when the 3D parallax makes it appear close.

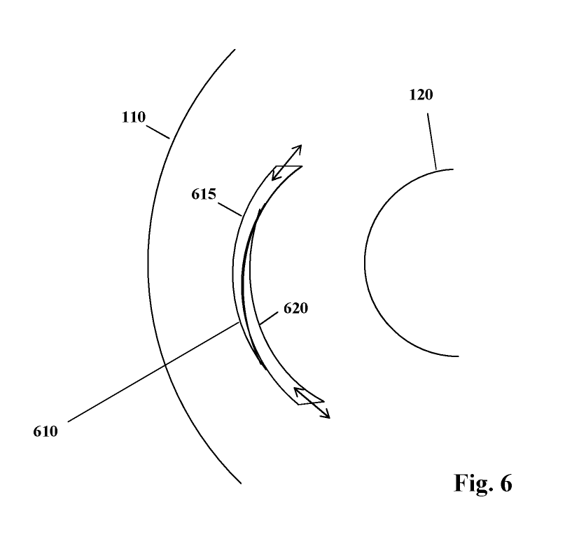

FIG. 6 illustrates a way to add vision correction. An adjustable vision correcting lens 610 is disposed between the concave image source 110 and the hemispherical lens 120. This lens 610 is formed by two complementary spherical half lenses 615, 620, each of which has one spherical lens surface and one abutting surface. The two abutting surfaces are complementary surfaces. The lens 610 can change thickness on translation of the two half lenses relative to each other along opposing circumferential paths, as indicated by the arrows associated with each half lens. A change in the thickness of the lens 610 enables the power of the HMD 100 to be easily changed during use. This allows a single HMD to accommodate multiple users with different ophthalmic correction prescriptions. By having a marked scale, the users can remember their personal settings or simply adjust the thickness of the spherical shell 610 to obtain the best image. By tilting the lens 610, astigmatism can also be introduced in any axis. Alternatively, the lens 610 may also be placed on the other side of the hemispherical lens (i.e., after the spherical lens 130) but in this position it may tend to interfere with the beam splitter 140.

So far, the HMD has been described as a monocular HMD displaying images directly in front of one eye and capable of providing a panoramic field of view. When two of these devices are combined in a binocular arrangement, three dimensional images can be displayed by sending a different image to each eye through well known processes. Since the HMD with panoramic field of view produces high resolution imagery centered on the eye by design, the eyes don't have to be in any precise orientation nor do they need to be tracked in order to maintain a high quality three dimensional image. This eliminates the need to tightly control the position of the head and the eyes relative to the projection system and makes it much easier to accommodate nearly all users by building a few sizes of the device.

With this system, a visual mapping from the concave image source 110 to the retina of the eye may require some remapping of the video signal by real-time electronics to keep the two eyes in registration for best clarity and creating the desired three dimensional effects. This type of processing is well known to those of skill in the relevant arts.

Thus a head mounted display (HMD) having a panoramic field of view is disclosed. While embodiments of these inventions have been shown and described, it will be apparent to those skilled in the art that many more modifications are possible without departing from the inventive concepts herein. The inventions, therefore, are not to be restricted except in the spirit of the following claims.

What is claimed is:

1. An optical instrument comprising:
a concave image source,
a first hemispherical lens optically coupled to the concave image source,
a second hemispherical lens optically coupled to and abutted to the first hemispherical lens, and
a spherical mirror optically coupled to the concave image source through the first and second hemispherical lenses, wherein the first hemispherical lens, the second hemispherical lens, and the spherical mirror are optically concentric with the concave image source.

2. An optical instrument as in claim 1 further comprising a beam splitter optically coupled between the second hemispherical lens and the spherical mirror.

3. An optical instrument as in claim 1, wherein the first and second hemispherical lenses, in combination, image points on the concave image source onto a virtual spherical surface having a radius half as great as the spherical mirror.

4. An optical instrument as in claim 1, wherein the spherical mirror is geometrically concentric with the concave image source.

5. An optical instrument as in claim 1, further comprising a beam splitter optically coupled between the second hemispherical lens and the spherical mirror.

6. An optical instrument as in claim 5, further comprising a frame to which the concave image source, the first and second hemispherical lenses, the beam splitter, and the spherical mirror are coupled, wherein the frame is configured to be worn and to place the spherical mirror in front of a wearer's eye such that the spherical mirror and the eye are optically concentric.

7. An optical instrument as in claim 6, wherein the frame is further configured to place a geometric center of the spherical mirror in coincidence with a center of rotation of the eye of the wearer.

8. An optical instrument as in claim 6 wherein the frame is further configured to place a center of rotation for the eye of the wearer and the center of the second hemispherical lens equidistant from the beam splitter.

9. An optical instrument as in claim 6, further comprising an adjustable vision correcting lens optically coupled between the concave image source and the first hemispherical lens.

10. An optical instrument as in claim 9, wherein the vision correcting optical lens comprises first and second radial wedges.

11. An optical instrument as in claim 10, wherein a thickness of the vision correcting optical lens is adjustable by sliding the first and second radial wedges with respect to each other along a circumferential path.

12. An optical instrument as in claim 9, wherein divergence of an optical axis of the vision correcting element from a system optical axis corrects for astigmatism.

13. An optical instrument as in claim 1, wherein the concave image source comprises:
a flat surface display; and
an image converter optically coupled to the flat surface display, wherein the image converter is configured to form a concave image source from an image shown on the flat surface display.

14. A binocular head mounted display comprising a left monocle and a right monocle, wherein each monocle comprises the optical instrument of claim 1.
